(19) United States
(12) Patent Application Publication
(10) Pub. No.: US 2015/0071143 A1
(43) Pub. Date: Mar. 12, 2015

(54) METHOD AND APPARATUS FOR MANAGING PDN CONNECTION

(71) Applicant: Hucheng Wang, Beijing (CN)

(72) Inventor: Hucheng Wang, Beijing (CN)

(73) Assignee: CHINA ACADEMY OF TELECOMMUNICATIONS TECHNOLOGY, Beijing (CN)

(21) Appl. No.: 14/236,023

(22) PCT Filed: Jul. 24, 2012
(86) PCT No.: PCT/CN2012/079086

§ 371 Date: Mar. 28, 2014

(30) Foreign Application Priority Data
Jul. 29, 2011 (CN) 201110215097.4

(51) Int. Cl. H04W 76/06; H04W 52/02

(52) U.S. Cl. CPC H04W 76/064; H04W 52/0209
USPC 370/311

(57) ABSTRACT

Examples of the present disclosure provide a method and apparatus for managing a PDN connection. In the method, a core network control entity determines that UE enters an idle state, determines a PDN connection corresponding to the UE as a PDN connection of a designated type and cancels the PDN connection of the designated type.

### CROSS REFERENCE TO RELATED APPLICATIONS

This application is a U.S. National Phase application under 35 U.S.C. §371 of International Application No. PCT/CN2012/079086, filed on Jul. 24, 2012, which claims priority to Chinese Patent Application No. 201110215097.4, filed on Jul. 29, 2011, the entire contents of which are incorporated herein by reference.

### TECHNICAL FIELD

The present disclosure relates to communication technologies, and more particularly, to a method and apparatus for managing a PDN connection.

### BACKGROUND

In conventional Evolved Packet System (EPS) systems, Packet Data Network (PDN) connection has a characteristic of always-on, i.e. a PDN connection in a core network is always online, and the PDN connection is called persistent connectivity. Hence, once User Equipment (UE) establishes the PDN connection, a default bearer of the PDN connection is always exist in the lift time of the PDN connection.

In the EPS system, the release of the PDN connection is decided by a Mobility Management Entity (MME), or decided by a Policy and Charging Rules Function (PCRF) or a Packet Data Gateway (PGW) according to strategies of operators.

In a procedure of implementing the present disclosure, following problems of the conventional technologies are found by inventors.

The conventional PDN connection solutions are designed for communication between people, and there is no solution for managing PDN connection of a large number of Machine Type Communication (MTC) devices.

### SUMMARY

Examples of the present disclosure provide a method and apparatus for managing a PDN connection, so as to manage PDN connections of a large number of MTC devices.

A method for managing a PDN connection includes:

determining, by a core network control entity, that User Equipment (UE) enters an idle state;

determining, by the core network control entity, a PDN connection corresponding to the UE as a PDN connection of a designated type; and

canceling, by the core network control entity, the PDN connection of the designated type.

A method for managing a PDN connection includes:

determining, by a Packet Data Gateway (PGW), a PDN connection corresponding to User Equipment (UE) as of a PDN connection designated type;

configuring, by the PGW, an inactive timer for the PDN connection of the designated type;

determining, by the PGW, that the PDN connection of the designated type enters an inactive state according to the inactive timer; and

canceling, by the PGW, the PDN connection of the designated type.

A method for managing a PDN connection includes:

receiving, by a PGW, an instruction of canceling a PDN connection of a designated type from a PCRF, when the PDN connection of the designated type enters an idle state;

canceling, by the PGW, the PDN connection of the designated type according to the instruction.

A core network control entity includes:

a first determining module, to determine that User Equipment (UE) enters an idle state;

a second determining module, to determine a Packet Data Network (PDN) connection corresponding to the UE as a PDN connection of a designated type; and

a canceling module, to cancel the PDN connection of the designated type.

A PGW includes:

a first determining module, to determine a Packet Data Network (PDN) connection corresponding to User Equipment (UE) as a PDN connection of a designated type;

a configuring module, to configure an inactive timer for the PDN connection of the designated type;

a second determining module, to determine that the PDN connection of the designated type enters an inactive state according to the inactive timer; and

a canceling module, to cancel the PDN connection of the designated type.

Compared with the conventional technologies, the present disclosure includes the following advantages.

PDN connections of a large number of MTC devices are managed effectively, resources occupied by the PDN connections are saved, it is unnecessary to spend many resources to manage the PDN connections, and performances of the system is improved.

### BRIEF DESCRIPTION OF THE DRAWINGS

FIG. 1 is a schematic flowchart illustrating a method for managing a PDN connection according to a first example of the present disclosure.

FIG. 2 is a schematic flowchart illustrating a method for managing a PDN connection according to a second example of the present disclosure.

FIG. 3 is a schematic flowchart illustrating a method for managing a PDN connection according to a third example of the present disclosure.

FIG. 4 is a schematic flowchart illustrating a method for managing a PDN connection according to a fourth example of the present disclosure.

FIG. 5 is a schematic flowchart illustrating a method for managing a PDN connection according to a fifth example of the present disclosure.

FIG. 6 is a schematic flowchart illustrating a method for managing a PDN connection according to a sixth example of the present disclosure.

FIG. 7 is a schematic diagram illustrating a core network control entity according to a seventh example of the present disclosure.

FIG. 8 is a schematic diagram illustrating a PGW according to an eighth example of the present disclosure.

FIG. 9 is a schematic diagram illustrating another PGW according to a ninth example of the present disclosure.

### DETAILED DESCRIPTION

In a procedure of implementing the present disclosure, the inventor notices that, a conventional PDN connection has a characteristic of always-on and current MTC communications are provided for a large number of MTC devices. When MTC applications are different, the MTC device may spend different periods of time using the PDN connection. For example, the duration of transmitting data via a PDN connection by a certain application is far less than idle time of the PDN connection, and thus resources occupied by the PDN connection established by the application are wasted. Further, numerous MTC devices correspond to a lot of PDN connections, and thus many resources are needed to manage the PDN connections, which affects performances of the system.

Therefore, the problem of managing PDN connections corresponding to numerous MTC devices in the network needs to be solved. Examples of the present disclosure provide a method and apparatus for managing a PDN connection, so as to manage PDN connections of numerous MTC devices, save resources occupied by the PDN connections, prevent expending many resources in managing the PDN connections and improve performances of the system.

Technical solutions of the present disclosure will be illustrated in detail hereinafter with reference to the accompanying drawings. The described examples are parts of examples of the present disclosure. Other examples obtained by those skilled in the art without creative labour based on the examples of the present disclosure belong to the protection scope of the invention.

A first example is provided.

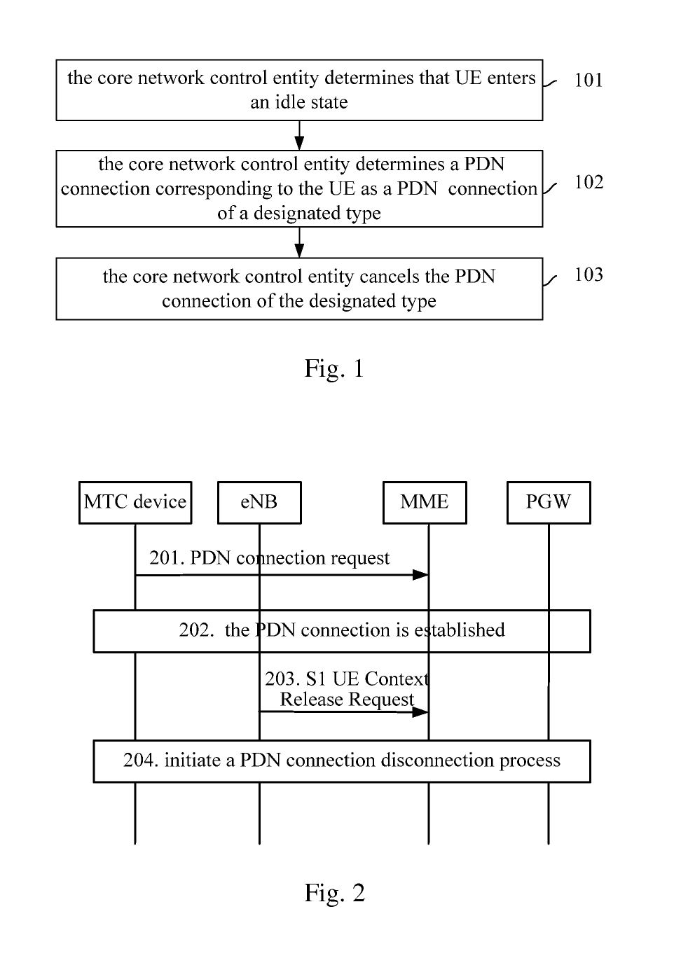

The first example provides a method for managing a PDN connection, and a core network control entity, e.g. a MME manages the PDN connection. As shown in FIG. 1, the method includes following processing.

At 101, the core network control entity determines that UE enters an idle state.

In an example, when a base station device, e.g. an eNB detects that the UE does not transmit data, the base station device transmits a S1 UE Context Release Request to the core network control entity, and a cause value is user inactivity. When determining that the cause value is the user inactivity, the core network control entity determines that the UE enters the idle state.

At 102, the core network control entity determines a PDN connection corresponding to the UE as a PDN connection of a designated type.

In a first mode, in subscription information of the UE, an Access Point Name (APN) identifier used for establishing temporarily connectivity may be configured for the APN. The temporarily connectivity is a PDN connection used temporarily. In this case, when detecting that the PDN connection corresponding to the UE uses an APN for establishing the temporarily connectivity, the core network control entity determines the PDN connection corresponding to the UE as the PDN connection of the designated type.

In an example of the present disclosure, at a network side, two types of APNs may be configured for the PDN connection of the UE according to application characteristics of the UE. One is an APN used for establishing “persistent connectivity”, and the other is an APN used for establishing “temporarily connectivity”. The APN used for establishing a PDN connection of “temporarily connectivity” is configured for the PDN connection of the designated type, e.g. a PDN connection of the MTC device. In the examples of the present disclosure, the APN of the first type will not be described, and the APN of the second type, i.e. the APN for establishing temporarily connectivity is called MTC SPECIFIED APN.

It should be noted that, the APN refers to an access point name, and is used by the network as a parameter for selecting the PGW. In addition, the APNs with different identifiers may be used to identify different types of PDN connections. For example, an identifier of LIPA APN indicates LIPA access, and an identifier of SIPTO APN indicates SIPTO access. The APNs are identified by these identifiers stored in the subscription data of the UE.

In an example of the present disclosure, when needing to configure the APN for the PDN connection of the designated type, the APN is configured as the MTC SPECIFIED APN in the subscription information, that is, the PDN connection of the designated type will use the MTC SPECIFIED APN. Afterwards, when it is detected that the UE enters in the idle state, the APN identifier corresponding to each of the PDN connections of the UE is checked. If it is determined that the APN identifier corresponding to the PDN connection is the MTC SPECIFIED APN which is the identifier of the APN used for establishing temporarily connectivity, the core network control entity determines that the PDN connection corresponding to the UE is the PDN connection of the designated type.

In a second mode, in subscription information of the UE, an attribute of infrequent data transmission may be configured for the UE according to requirements of the UE. In this case, when the core network control entity detects that the UE has the attribute of infrequent data transmission, the core network control entity determines the PDN connection corresponding to the UE as the PDN connection of the designated type.

In an example of the present disclosure, the network side may configure the attribute of infrequent data transmission for the UE (i.e. the MTC device) in the subscription information of the UE according to application characteristics of the UE. Afterwards, when it is detected that the UE enters the idle state, the subscription information of the UE is checked. If it is determined that subscription information of the UE has the attribute of infrequent data transmission, the core network control entity determines each of all normal PDN connections of the UE as the PDN connection of the designated type.

At 103, the core network control entity cancels the PDN connection of the designated type. According to various examples, the core network control entity may cancel the PDN connection of the designated type via a PDN connection disconnection procedure or via an implicit detach procedure.

In an example of the present disclosure, for the PDN connection having the APN identifier used for establishing the temporality connectivity or for all PDN connections of the UE having the attribute of infrequent data transmission, when the UE enters the idle state because of no data transmission, the network side may initiate a PDN connection disconnection procedure to release the PDN connection associated with the APN in the UE.

Afterwards, when a MTC Server needs to transmit data to the MTC device, i.e. the UE of the designated type, a MTC trigger characteristic may be used to trigger establishing of new connectivity.

Therefore, according to examples of the present disclosure, when the MTC device enters the idle state, the PDN connection disconnection procedure may be initiated to release the PDN connection, so that the PDN connection of the MTC device is managed effectively, the number of inactive PDN connections of the MTC device is reduced. When the MTC device does not often perform data transmission, the duration of accessing to the network is reduced as much as possible.

A second example is provided.

Based on the first example, the second example provides a method for managing a PDN connection, and a core network control entity, e.g. a MME manages the PDN connection. As shown in FIG. 2, the method includes following processing.

At 201, a MTC device establishes a PDN connection by using a MTC SPECIFIED APN. In an example, the MTC device may send a PDN connection request for the MTC SPECIFIED APN to the MME.

At 202, the PDN connection is established via checking subscription information of the MTC device.

At 203, when UE does not transmit data, an eNB send a S1 UE Context Release Request, the cause value is user inactivity.

At 204, the MME initiates a PDN connection disconnection procedure when determining that the cause value in the S1 UE Context Release Request is the user inactivity, so as to disconnect all PDN connections using the MTC SPECIFIED APN.

A third example is provided.

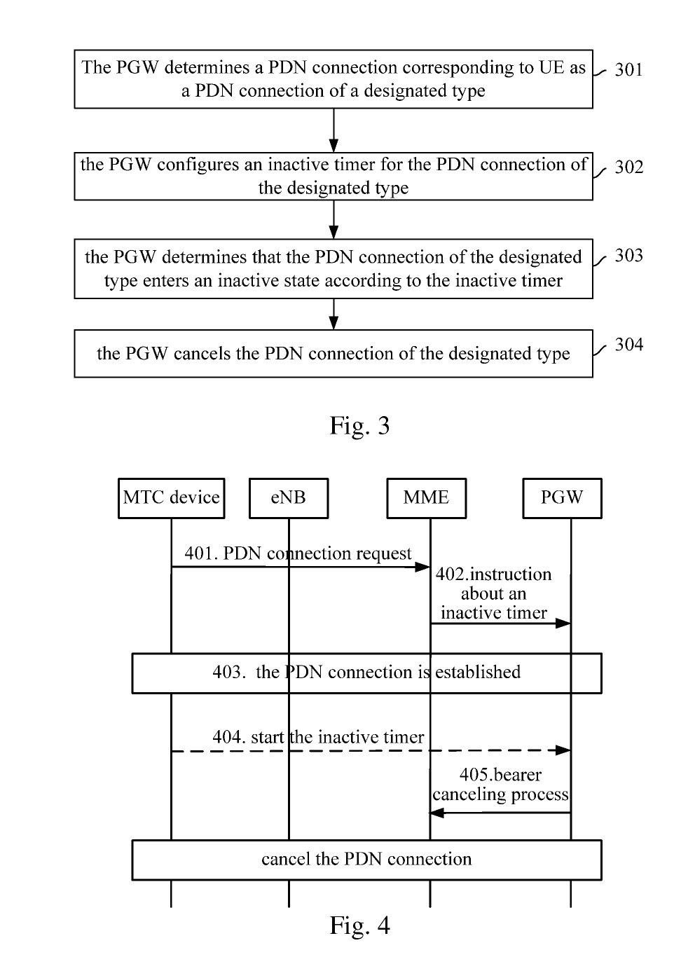

The third example provides a method for managing a PDN connection, and a PGW manages the PDN connection. As shown in FIG. 3, the method includes following processing.

At 301, the PGW determines a PDN connection corresponding to UE as a PDN connection of a designated type.

In a first mode, an APN identifier used for establishing temporarily connectivity may be configured for APN in subscription information of the UE. The temporarily connectivity is a PDN connection used temporarily. In this case, the PGW may receive a notification from a core network control entity. When the notification includes a first identifier indicating that the PDN connection corresponding to the UE uses an APN for establishing temporarily connectivity, the PGW determines the PDN connection corresponding to the UE as the PDN connection of the designated type.

In an example of the present disclosure, at a network side, two types of APNs may be configured for the PDN connection of the UE according to application characteristics of the UE. One is an APN used for establishing “persistent connectivity”, and the other is an APN used for establishing “temporarily connectivity”. The APN used for establishing a PDN connection of “temporarily connectivity” is configured for the PDN connection of the designated type, e.g. a PDN connection of the MTC device. In the examples of the present disclosure, the APN of the first type will not be described, and the APN of the second type, i.e. the APN for establishing temporarily connectivity is called MTC SPECIFIED APN.

In an example of the present disclosure, when needing to configure the APN for the PDN connection of the designated type, the APN is configured as the MTC SPECIFIED APN in the subscription information, that is, the PDN connection of the designated type will used the MTC SPECIFIED APN. The MTC SPECIFIED APN may be configured for the PDN connection of the designated type by an MME, and the MME notifies the PGW of the MTC SPECIFIED APN. For example, the MME may notify the PGW that the APN of the PDN connection is the MTC SPECIFIED APN or the MME may statically configure processing strategy for this type of APN on the PGW. Afterwards, the PGW may determine the PDN connection corresponding to the UE as the PDN connection of the designated type according to an identifier of the APN for establishing temporarily connectivity.

In a second mode, in subscription information of the UE, an attribute of infrequent data transmission may be configured for the UE according to requirements of the UE. In this case, the PGW may receive a notification from the core network control entity. When the notification includes a second identifier indicating that the UE has the attribute of infrequent data transmission, the PGW determines all normal PDN connections of the UE as the PDN connection of the designated type.

In an example of the present disclosure, the network side may configure the attribute of infrequent data transmission for the UE (i.e. the MTC device) in the subscription information of the UE according to application characteristics of the UE. According to an example, the MME may configure the attribute of infrequent data transmission for the UE and notify the PGW. For example, the MME may notify the PGW that the UE has the attribute of infrequent data transmission. The PGW determines all normal PDN connections of the UE as the PDN connection of the designated type.

At 302, the PGW configures an inactive timer for the PDN connection of the designated type.

In an example of the present disclosure, after the PDN connection is determined as the PDN connection of the designated type, the PGW configures the inactive timer for the PDN connection of the designated type, starts the inactive timer when detecting that no data is transmitted via the PDN connection, and resets the inactive timer when detecting that data is transmitted via the PDN connection again.

At 303, the PGW determines that the PDN connection of the designated type enters an inactive state according to the inactive timer. According to an example, after the inactive timer expires, the PGW determines that the PDN connection of the designated type enters the inactive state.

At 304, the PGW cancels the PDN connection of the designated type. According to various examples, the PGW cancels the PDN connection of the designated type via a bearer deactivation procedure, that is, the PGW initiates a bearer deactivation procedure to deactivate the default bearer of the PDN connection.

Afterwards, when the MTC server needs to transmit data to the MTC device, i.e. the UE of the designated type, the MTC trigger characteristics may be used to initiate establishing of a new connectivity.

Therefore, according to examples of the present disclosure, on the PGW, the inactive timer is configured for the PDN connection of the MTC device. When the inactive timer expires, the PDN connection is released, so that the PDN connection of the MTC device is managed effectively, the number of inactive PDN connections of the MTC device is reduced. When the MTC device does not often perform data transmission, the duration of accessing to the network is reduced as much as possible.

A fourth example is provided.

Based on the third example, the fourth example provides a method for managing a PDN connection, and a PGW manages the PDN connection. As shown in FIG. 4, the method includes following processing.

At 401, a MTC device establishes a PDN connection by using a MTC SPECIFIED APN. In an example, the MTC device may send a PDN connection request for the MTC SPECIFIED APN to a MME.

At 402, the MME checks subscription information, notifies the PGW to start an inactive timer for the APN after data transmission is completed. Further, the MME may notify the PGW of the timer value.

At 403, the PDN connection is established.

At 404, after the data transmission is completed, the PGW starts the inactive timer, and a timer value is decided according to configuration.

At 405, after the inactive timer expires, the PGW initiates a bearer canceling procedure to cancel the default bearer, so as to cancel the PDN connection.

It should be noted that, if data transmission is performed via the PDN connection again before the inactive timer expires, the inactive timer is reset.

A fifth example is provided.

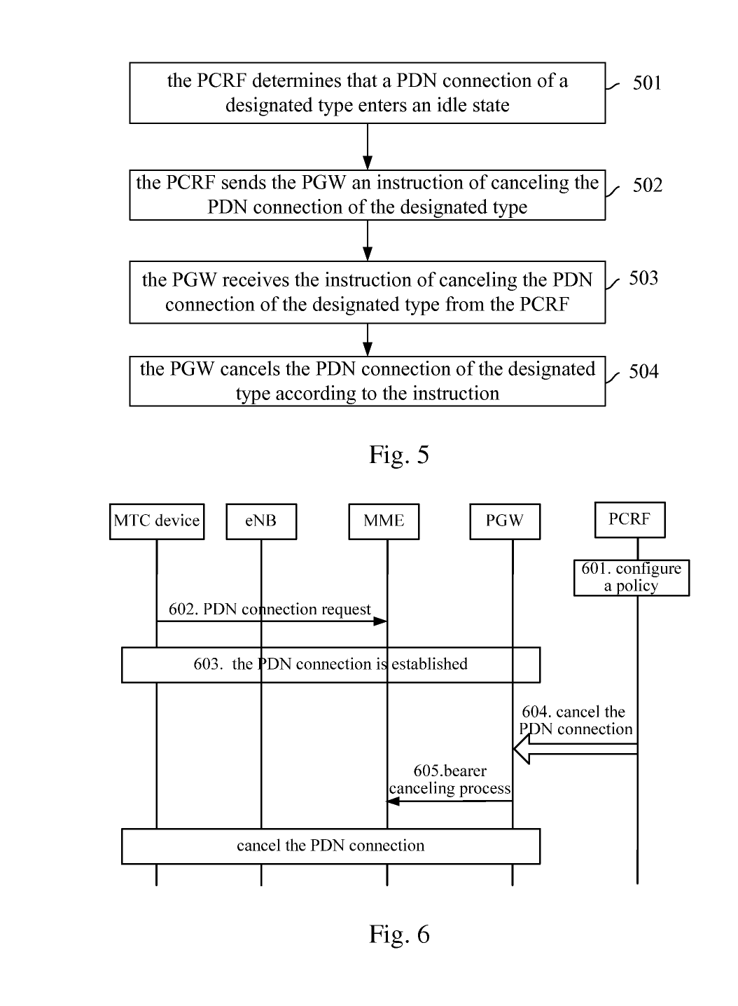

The fifth example provides a method for managing a PDN connection, and a PCRF and a PGW manage the PDN connection. As shown in FIG. 5, the method includes following processing.

At 501, the PCRF determines that a PDN connection of a designated type enters an idle state.

According to an example, the PCRF may determine that the PDN connection of the designated type enters the idle state by using modes as described in the above examples.

At 502, the PCRF sends the PGW an instruction of canceling the PDN connection of the designated type.

According to an example, a policy for the MTC SPECIFIED APN may be configured on the PCRF, so that the PCRF may send the instruction of canceling the PDN connection of the designated type to the PGW after the transmission on the PDN connection is completed for a preset time period.

At 503, the PGW receives the instruction of canceling the PDN connection of the designated type from the PCRF.

At 504, the PGW cancels the PDN connection of the designated type according to the instruction. According to an example, the PGW may cancel the PDN connection of the designated type via a bearer deactivation procedure, e.g. the PGW initiates a bearer deactivation procedure to deactivate the default bearer of the PDN connection.

A sixth example is provided.

Based on the above example, the sixth example provides a method for managing a PDN connection, and a PCRF and a PGW manage the PDN connection. As shown in FIG. 6, the method includes following processing.

At 601, the PCRF is configured with a policy in which an instruction of canceling a PDN connection is sent after a PDN connection using a MTC SPECIFIED APN enters an idle state for a certain time period.

At 602, a MTC device establishes a PDN connection by using a MTC SPECIFIED APN. According to an example, the MTC device may send the MME a PDN connection request for the MTC SPECIFIED APN.

At 603, the PDN connection is established.

At 604, after detecting that the PDN connection enters the idle state for a certain time period, the PCRF sends an instruction of canceling the PDN connection to a PGW.

At 605, the PGW receives the instruction of canceling the PDN connection, initiates a bearer canceling procedure to cancel the default bearer, so as to cancel the PDN connection.

A seventh example is provided.

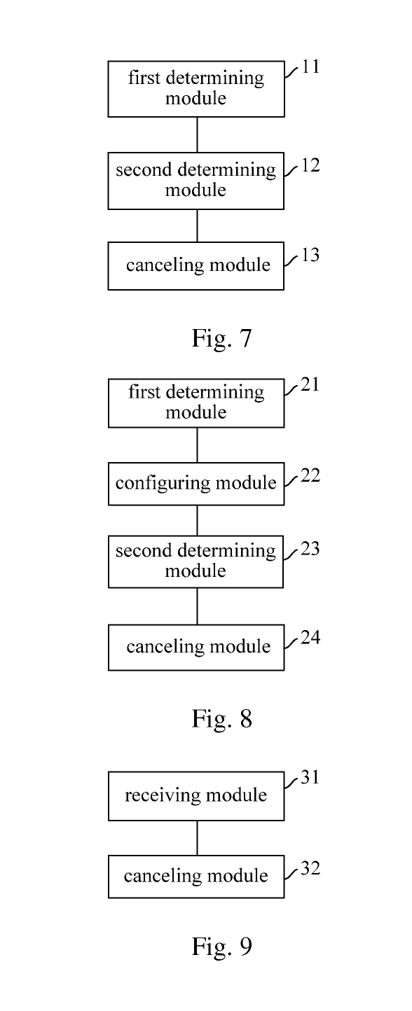

Based on the same inventive concept, the examples of the present disclosure also provide a core network control entity, as shown in FIG. 7. The core network control entity includes a first determining module 11, a second determining module 12, and a canceling module 13.

The first determining module 11 is to determine that UE enters an idle state.

The second determining module 12 is to determine a PDN connection corresponding to the UE as a PDN connection of a designated type.

The canceling module 13 is to cancel the PDN connection of the designated type.

According to an example, the second determining module 12 is to determine the PDN connection corresponding to the UE as the PDN connection of the designated type when the PDN connection corresponding to the UE uses an APN for establishing temporarily connectivity.

It should be noted that, an APN identifier used for establishing temporarily connectivity may be configured for the APN in subscription information of the UE.

According to an example, the second determining module 12 is to determine each of normal PDN connections of the UE as the PDN connection of the designated type, when the UE has an attribute of infrequent data transmission.

It should be noted that, the attribute of infrequent data transmission is configured for the UE in subscription information of the UE according to requirements of the UE.

According to an example, the canceling module 13 is to cancel the PDN connection of the designated type via a PDN connection disconnection procedure or via an implicit detach procedure.

According to examples of the present disclosure, the modules in the core network control entity may be located together or separately. The above modules may be merged into one module, or may be divided into multiple sub-modules furthermore.

An eighth example is provided.

Based on the same inventive concept, the examples of the present disclosure also provide a PGW, as shown in FIG. 8. The PGW includes a first determining module 21, a configuring module 22, a second determining module 23, and a canceling module 24.

The first determining module 21 is to determine a PDN connection corresponding to UE as a PDN connection of a designated type.

The configuring module 22 is to configure an inactive timer for the PDN connection of the designated type.

The second determining module 23 is to determine that the PDN connection of the designated type enters an inactive state according to the inactive timer.

The canceling module 24 is to cancel the PDN connection of the designated type.

According to an example, the first determining module 21 is to receive a notification from a core network control entity; determine the PDN connection corresponding to UE as the PDN connection of the designated type, when the notification includes a first identifier indicating that the PDN connection uses an APN for establishing temporarily connectivity.

It should be noted that, in subscription information of the UE, an APN identifier used for establishing temporarily connectivity may be configured for the APN.

According to an example, the first determining module 21 is to receive a notification from the core network control entity; determine each of normal PDN connections of the UE as the PDN connection of the designated type, when the notification includes a second identifier indicating that the UE has an attribute of infrequent data transmission.

It should be noted that, in subscription information of the UE, the attribute of infrequent data transmission may be configured for the UE according to requirements of the UE.

According to an example, the canceling module is to cancel the PDN connection of the designated type via a bearer deactivation procedure.

According to examples of the present disclosure, the modules in the core network control entity may be located together or separately. The above modules may be merged into one module, or may be divided into multiple sub-modules furthermore.

A ninth example is provided.

Based on the same inventive concept, the examples of the present disclosure also provide a PGW, as shown in FIG. 9. The PGW includes a receiving module 31 and a canceling module 32.

The receiving module 31 is to receive an instruction of canceling a PDN connection of a designated type from a PCRF, when the PDN connection of the designated type enters an idle state.

The canceling module 32 is to cancel the PDN connection of the designated type according to the instruction.

According to an example, the canceling module 32 may cancel the PDN connection of the designated type via a bearer deactivation procedure.

According to examples of the present disclosure, the modules in the core network control entity may be located together or separately. The above modules may be merged into one module, or may be divided into multiple sub-modules furthermore.

According to the above descriptions of examples, it can be clearly understood by those skilled in the art that the present invention can be realized by software accompanying with necessary general hardware platforms, or by hardware. In many cases, the former is a preferred manner. Based on this, the essential part of the technical solution of the present invention or the part contributed to the prior art can be in the form of a software product, and the computer software product is stored in a storage medium and includes several codes to make a computer device (such as a handset, a personal computer, a server or a network device) perform the method in embodiments of the present invention.

Persons having ordinary skill in the art may easily learn that the accompanying drawings are only schematic diagrams of a preferred embodiment. The modules or processes illustrated in the accompanying drawings are not definitely necessary to implement the present invention.

Persons having ordinary skill in the art may understand that the modules in the device embodiment may be distributed in the device of the embodiment according to embodiment descriptions, or may change correspondingly to locate in one or more devices different from the embodiment. The modules in above embodiment may be merged into one module, or may be divided into multiple sub-modules furthermore.

Sequence number in above embodiments of the present invention is only used for descriptions, which doesn't demonstrate good or better embodiment.

The foregoing is only preferred examples of the present disclosure and is not used to limit the protection scope of the present disclosure. Any modification, equivalent substitution and improvement are within the protection scope of the present disclosure.

1. A method for managing a Packet Data Network (PDN) connection, comprising:
determining, by a core network control entity, that User Equipment (UE) enters an idle state;
determining, by the core network control entity, a PDN connection corresponding to the UE as a PDN connection of a designated type; and
canceling, by the core network control entity, the PDN connection of the designated type.

2. The method of claim 1, wherein determining, by the core network control entity, the PDN connection corresponding to the UE as the PDN connection of the designated type comprises:
determining the PDN connection corresponding to the UE as the PDN connection of the designated type, when the PDN connection corresponding to the UE uses an Access Point Name (APN) for establishing temporarily connectivity.

3. The method of claim 2, wherein
an APN identifier used for establishing temporarily connectivity is configured for the APN in subscription information of the UE.

4-20. (canceled)

21. The method of claim 1, wherein determining, by the core network control entity, the PDN connection corresponding to the UE as the PDN connection of the designated type comprises:
determining each of normal PDN connections of the UE as the PDN connection of the designated type, when the UE has an attribute of infrequent data transmission.

22. The method of claim 21, wherein the attribute of infrequent data transmission is configured for the UE in subscription information of the UE according to requirements of the UE.

23. A method for managing a Packet Data Network (PDN) connection, comprising:
determining, by a Packet Data Gateway (PGW), a PDN connection corresponding to User Equipment (UE) as of a PDN connection designated type;
configuring, by the PGW, an inactive timer for the PDN connection of the designated type;
determining, by the PGW, that the PDN connection of the designated type enters an inactive state according to the inactive timer; and
canceling, by the PGW, the PDN connection of the designated type.

24. The method of claim 23, wherein determining, by the PGW, that the PDN connection corresponding to the UE as the PDN connection designated type comprises:
receiving, by the PGW, a notification from a core network control entity; and
determining the PDN connection corresponding to the UE as the PDN connection of the designated type, when the notification comprises a first identifier indicating that the PDN connection uses an Access Point Name (APN) for establishing temporarily connectivity.

25. The method of claim 24, wherein
an APN identifier used for establishing temporarily connectivity is configured for the APN in subscription information of the UE.

26. The method of claim 23, wherein determining, by the PGW, that the PDN connection corresponding to the UE as the PDN connection designated type comprises:
receiving, by the PGW, a notification from the core network control entity; and
determining each normal PDN connections of the UE as the PDN connection of the designated type, when the notification comprises a second identifier indicating that the UE has an attribute of infrequent data transmission.

27. The method of claim 26, wherein the attribute of infrequent data transmission is configured for the UE in subscription information of the UE according to requirements of the UE.

28. A method for managing a Packet Data Network (PDN) connection, comprising:
receiving, by a PGW, an instruction of canceling a PDN connection of a designated type from a PCRF, when the PDN connection of the designated type enters an idle state;
canceling, by the PGW, the PDN connection of the designated type according to the instruction.

29. A core network control entity, comprising: a processor for executing instructions stored in a memory, wherein the instructions comprise:
a first determining instruction, to determine that User Equipment (UE) enters an idle state;
a second determining instruction, to determine a Packet Data Network (PDN) connection corresponding to the UE as a PDN connection of a designated type; and
a canceling instruction, to cancel the PDN connection of the designated type.

30. The core network control entity of claim 29, wherein
the second determining instruction is to
determine the PDN connection corresponding to the UE as the PDN connection of the designated type when the PDN connection corresponding to the UE uses an Access Point Name (APN) for establishing temporarily connectivity.

31. The core network control entity of claim 30, wherein
an APN identifier used for establishing temporarily connectivity is configured for the APN in subscription information of the UE.

32. The core network control entity of claim 29, wherein
the second determining instruction is to determine each of normal PDN connections of the UE as the PDN connection of the designated type, when the UE has an attribute of infrequent data transmission.

33. The core network control entity of claim 32, wherein the attribute of infrequent data transmission is configured for the UE in subscription information of the UE according to requirements of the UE.

34. A Packet Data Gateway (PGW), comprising: a processor for executing instructions stored in a memory, wherein the instructions comprise:
a first determining instruction, to determine a Packet Data Network (PDN) connection corresponding to User Equipment (UE) as a PDN connection of a designated type;
a configuring instruction, to configure an inactive timer for the PDN connection of the designated type;
a second determining instruction, to determine that the PDN connection of the designated type enters an inactive state according to the inactive timer; and
a canceling instruction, to cancel the PDN connection of the designated type.

35. The PGW of claim 34, wherein
the first determining instruction is to
receive a notification from a core network control entity; determine the PDN connection corresponding to the UE as the PDN connection of the designated type, when the notification comprises a first identifier indicating that the PDN connection uses an Access Point Name (APN) for establishing temporarily connectivity.

36. The PGW of claim 35, wherein
an APN identifier used for establishing temporarily connectivity is configured for the APN in subscription information of the UE.

37. The PGW of claim 34, wherein
the first determining instruction is to receive a notification from the core network control entity; determine each of normal PDN connections of the UE as the PDN connection of the designated type, when the notification comprises a second identifier indicating the UE has an attribute of infrequent data transmission.

38. The PGW of claim 37, wherein
the attribute of infrequent data transmission is configured for the UE in subscription information of the UE according to requirements of the UE.
